(19) United States
(12) Patent Application Publication
(10) Pub. No.: US 2009/0102181 A1
(43) Pub. Date: Apr. 23, 2009

(54) PLUG-IN CONNECTION ON PIPES AND HOSES WITH A PIPE DETENT RING

(76) Inventor: Harald Hartmann, Dornbirn (DE)

Correspondence Address: BROWDY AND NEIMARK, P.L.L.C.;624 NINTH STREET, NW, SUITE 300, WASHINGTON, DC, 20001-5303, US

(21) Appl. No.: 12/091,027

(22) PCT Filed: Jan. 13, 2006
(86) PCT No.: PCT/EP2006/000264

§ 371 Date: Sep. 29, 2008

(30) Foreign Application Priority Data
Oct. 21, 2005 (DE) 102005050490.6

(51) Int. Cl. F16L 37/00

(52) U.S. Cl. 285/26

(57) ABSTRACT

The invention relates to a plug-in connection for pipes and tubes, said connection a tubular plug (20) which can be respectively connected to a pipe and/or a tube with a front side thereof and can be inserted into each in a sealing manner with the other front side thereof and engaged together in a secure, axially form-fitting manner. The connecting piece (1) comprises a tube engaging ring (3) on the tube (2) thereof, which forms an engaging groove (7) in which a catch spring (24) of the plug (20) at least partially engages, the tube engaging ring (3) being embodied as a part which is separate from the connecting piece (1) and secured thereon in a form-fitting manner with little play, or fixed thereto in a form fitting or fictionally engaged manner without play. It is advantageous that the plug-in connection can be produced in an essentially simple manner and can also be subjected to an essentially higher axial load.

The invention relates to a plug-in connection on pipes and hoses according to the preamble of claim 1. Plug-in connections of this type have become known from a multitude of patents by the same applicant, to which reference is hereby made. The function of the plug-in connection has been described there multiple times.

The plug-in connection serves to provide a locking and sealing connection between a connecting piece and a plug.

In the language of the present invention, the connecting piece is always fixed on a pipe, whereas the plug is fixed on a hose. The invention is not limited to this, however. The reverse configuration may be provided for as well, whereby the plug is fixed on the pipe and the connecting piece is fixed on the hose. To keep the description simple, however, it will be based only on the first-mentioned embodiment.

An exemplary embodiment of the present invention, for example, relates to a land vehicle, aircraft, or water craft having a cooler to which a tubular connecting piece is integrally connected. At the front of this connecting piece a pluggable sealing detent connection must now be made to a hose that connects at that point.

This hose, in turn, is connected at its opposite end to a plug, which enters into a detent connection there with a pipe, the free end of which, in turn, has a connecting piece disposed on it.

Disposed on the opposite end of the pipe, in turn, is a connecting piece, which cooperates with a plug of a hose and the opposite end of this hose, in turn, is provided with a plug, which enters into a sealing detent connection with a connecting piece, which is fixed on a pipe that represents the feed line to a turbo supercharger.

Over the length of this connection between a cooler and a turbo supercharger, altogether four different plug-in connections are thus provided.

As explained at the beginning, these plug-in connections are described in a multitude of patents by the same applicant. The full scope of the disclosure in those patent documents is hereby referenced.

In the described exemplary embodiment, gaseous media with a temperature of approximately 130 to 200° C. and a pressure of 5 bar are carried. The invention is not limited to this, however. The invention relates to all pluggable and detenting pipe connections, be it for carrying liquids, for carrying gas, or for carrying powdery or granulated substances.

A problem with detenting plug-in connections of this type, on which high sealing demands are placed, is that the detent means on the connecting piece side can be installed only with difficulty.

In older patents of the applicant's, it is described that the detent means on the connecting-piece side is connected directly to the pipe of the connecting piece in such a way that it is welded to it or formed integrally out of the pipe. This has the shortcoming, however, of a relatively high production expenditure.

When shaping the detent means (detent ring) out of the material of the connecting piece, numerous compromises must be made. The shortcoming exists, for example, that one cannot shape very acute radii, which adversely affects the detenting action of the pluggable detent connection. As a result, the attained pull-out forces are not very high.

Certain items cannot be formed-on at all, such as, e.g., a cam that serves as an anti-twist protection for the detent connection. A cam of this type must be formed-on retroactively by means of welding, joining or gluing processes, which involves a considerable expenditure.

Since the cam serves to provide an anti-twisting protection, and it is therefore stressed on a torsional load, the danger exists in the case of such a—retrofitted—connection that the cam may be sheared off.

The invention is therefore based on the object of improving the detent means on the connecting piece side of a detenting plug-in connection in such a way that it can be produced much more easily, more stressable, and with improved pull-out forces.

To meet the object at hand, the invention is characterized in that the pipe detent ring is implemented as a part that is separate from the connecting piece and that is form-fittingly secured to the same with little play, or fixed to it in a form-fitting and frictionally engaging manner without play.

Specifically, a separate pipe detent ring is fixed on the outer periphery of a connecting piece that has not been prepared per se.

With the technical teaching of the claimed subject matter, the significant advantage results that it has now been recognized for the first time that it is quite possible to separate the detenting function from the sealing function of the connecting piece, and this realization has led to the result that one now provides a separate pipe detent ring, which is fixed mechanically stable on the outer periphery of the connecting piece by means of a suitable fixing process.

This results in the advantage that the connecting piece must be machined only to a small extent, since its sealing surface, which enters into the sealing connection with the opposed plug, remains completely unmachined and not impacted.

Only in the axial direction behind the sealing surface on the outer periphery of the connecting piece is the inventive separate pipe detent ring now fixed by means of suitable fixing means.

A fixing of this type does not need to be sealing, since the sealing surface that is situated in front of it attains the actual sealing effect. It is therefore adequate to provide a mechanically stressable connection between the inventive pipe detent ring and the outer periphery of the connecting piece.

In a first preferred embodiment, provision is made that the pipe detent ring is connected to the connecting piece by means of a press fitting. A spreading tool is applied for this purpose from the inner periphery of the connecting piece, which creates a radially outwardly directed press groove that engages into a corresponding securing groove in the region of the pipe detent ring and thereby holds the same mechanically stable on the outer periphery.

In a second preferred embodiment, provision may be made that the pipe detent ring is fixed to the outer periphery of the connecting piece by means of a gluing process or welding process.

In a third embodiment, provision may be made that the pipe detent ring is pressed into the periphery of the connecting piece by means of appropriate pressing tools that act from the outside and are directed radially inward.

In a fourth embodiment, provision is made that projections are worked out from the material of the connecting piece, which cooperate with corresponding projections and/or recesses of the detent ring, thereby fixing the same with a positive fit (form-fittingly) on the outer periphery.

All embodiments thus have in common that only a form-fitting connection between the pipe detent ring and the outer periphery of the connecting piece is required, which does not need to have a sealing effect, however.

This invention, in other respects, is not limited to a deformable connecting piece that consists of a metal material. In another embodiment of the invention provision is made that the connecting piece consists of a plastic material and that the inventive pipe detent ring (which may consist of a plastic and/or metal material as well) is placed into the injection molding tool for producing the connecting piece and molded integrally in terms of material onto the material of the plastic connecting piece.

This integral union in terms of material pertains only to cases in which the pipe detent ring consists of a plastic material as well.

If it consists of a metal material and the connecting piece consists of a plastic material, it suffices to extrusion-coat the pipe detent ring in a suitable manner with the plastic material of the pipe connecting piece.

With the technical teaching of the claimed subject matter of all embodiments, there now results the significant advantage that, due to a pipe detent ring being fixed separately, it is now possible for the first time to achieve a detent ramp with a preferably small radius at the tip, wherein this small radius passes over into the detent groove that adjoins behind it. This results in very high pull-out forces, which were not attainable in the prior art.

It is an additional advantage that, based solely on the separate implementation of the pipe detent ring, a very smooth and only slightly sloped ramp can be attained, which has the advantage that only small plug-in forces are required when the entire detent device is properly centered.

In a preferred embodiment, provision is made that the pipe detent ring is implemented as two parts and consists of a detent ring and a lock ring adjoining the former downstream thereof integrally in terms of material.

This presents the advantage that two different functions are incorporated into the pipe detent ring. The anterior detent ring serves to provide for the detent connection with the plug, while the posterior lock ring serves for centering the detent connection, as an axial end stop, and as mechanical protection for the entire plug-in connection to prevent foreign bodies from entering into the detent region.

The additional advantage of the invention now lies in that it is no longer necessary—as it was required in the prior art—to connect a complete detent mechanism to a connecting piece by means of a joint connection. This means that joint areas are eliminated, which additionally also need to receive the entire sealing pressure of the pipe connection.

Due to the fact that the inventive pipe detent ring is disposed on the outer periphery of the connecting piece separately from the sealing configuration, it suffices to incorporate only the mechanical strength for the detent connection at that location.

With the technical teaching of the claimed subject matter, the additional advantage results that one can now retroactively fix pipe detent rings to the outer periphery of any desired connecting piece regardless of the pipe wall thickness and of the material of the connecting piece.

A pipe detent ring that is made of metal can even be pressed onto a connecting piece made of plastic, as long as this connecting piece is plastically cold formable and had a low elastic recovery.

It is an additional advantage that the inventive separate pipe detent ring may have a significantly higher strength than the material of the connecting piece in comparison, which as a rule must be easily deformable and soft.

This results in good detent values at a high wear resistance of the detent connection.

As the last advantage, it shall be mentioned that it is now possible in a simple way to form the anti-twist protection onto the pipe detent ring in the form of a cam, which used to involve significant additional time and expense.

It now suffices to form an appropriate cam out of the material of the pipe detent ring, which is possible in various ways.

In a first embodiment, provision may be made that the cam consists of a sheet metal material that is pushed out from the remaining sheet metal material of the pipe detent ring by means of a flanging tool.

Likewise, the cam may be formed of pushed out lobes of the pipe detent ring, and lastly the cam may also be inserted as a separate part in corresponding recesses on the pipe detent ring that are bordered by lobes.

It is important with all embodiments that it now suffices, in order to create the sealing effect, to calibrate the pipe of the connecting piece to a defined outer diameter only at its front end, since only this outer diameter acts as the sealing diameter for the plug-in connection.

All adjoining connecting piece areas downstream thereof will then no longer need to be calibrated to a precisely defined outer diameter.

The inventive object of the present invention is attained not only from the subject of the individual claims but also from the combination of the individual claims with one another.

All of the specifications and characteristics disclosed in the documents, including the abstract, and in particular the three-dimensional embodiment shown in the drawings, are claimed as essential to the invention, to the extent that they are novel either individually or in combination over the prior art.

The invention is described in further detail below in conjunction with drawings depicting only one possible embodiment route. Further characteristics that are essential to the invention and advantages of the invention will become apparent from these drawings and from their description.

In the drawings:

Figure A is a depiction of a connecting piece with a detent device according to the prior art

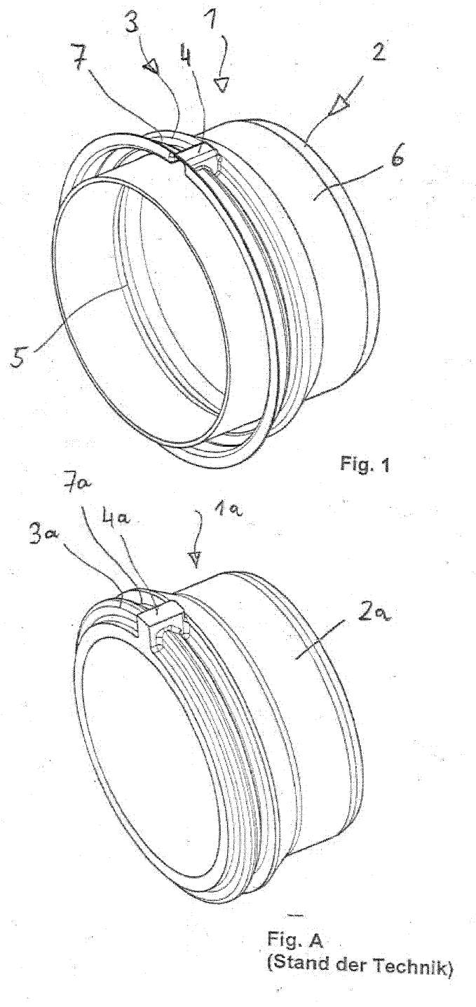

FIG. 1 shows a connecting piece with a detent ring according to the invention in a perspective rendering

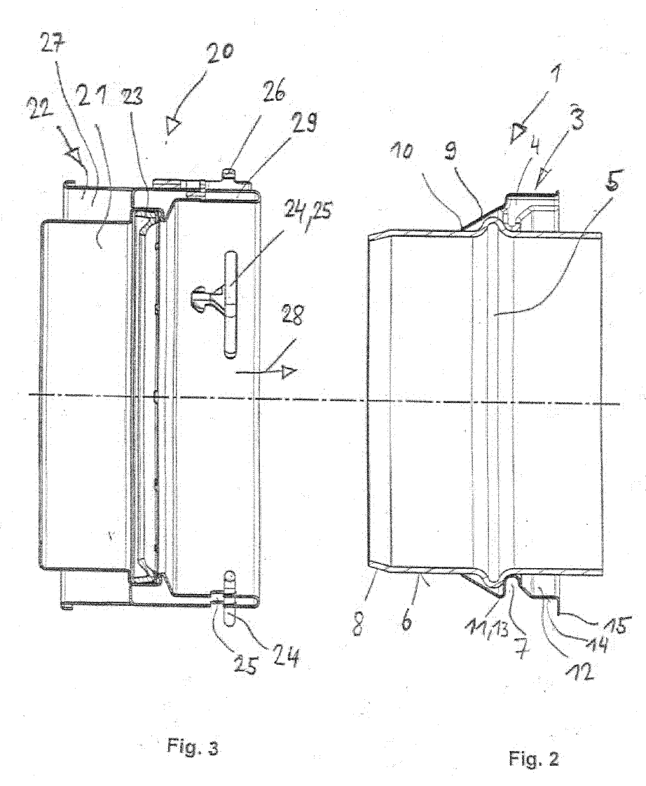

FIG. 2 shows a section through the connecting piece of FIG. 1

FIG. 3 shows a section through the plug

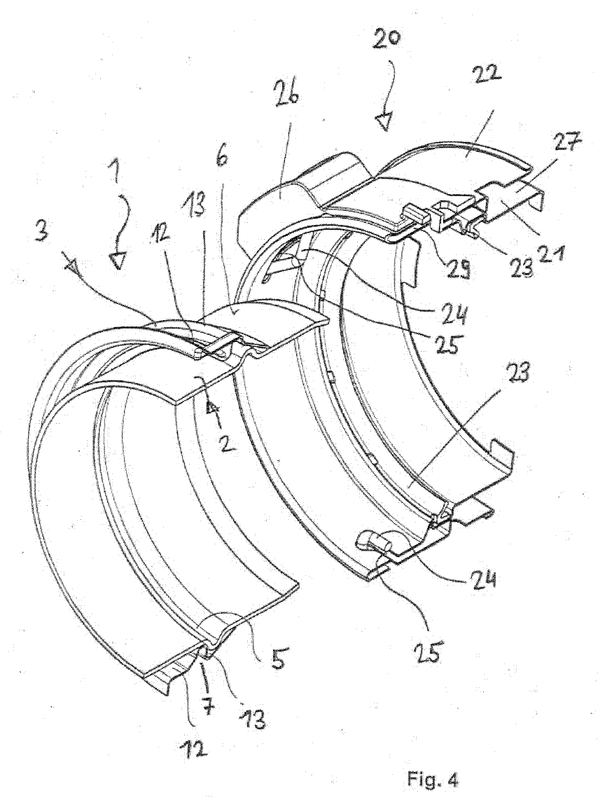

FIG. 4 shows a perspective half-section through the plug and connecting piece of FIGS. 2 and 3

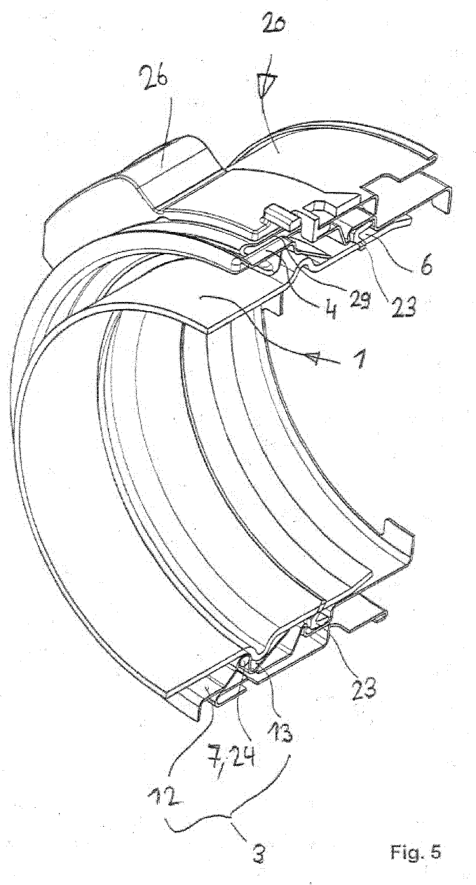

FIG. 5 shows the illustration of FIG. 4 in the assembled state

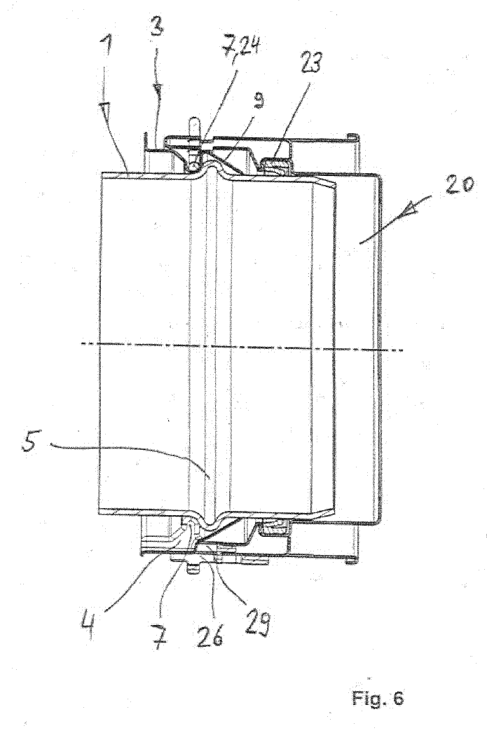

FIG. 6 shows a section through the configuration of FIG. 5

Figure A may be used to explain a connecting piece of the kind that belongs to the prior art. There, the connecting piece 1a consists of a pipe 2a on which a pipe detent ring 3a is formed integral therewith in terms of material. This pipe detent ring 3a is produced by reshaping the relatively soft material of the pipe 2a. This may also be a die-casting or injection molding process that was used to produce the entire configuration.

With this configuration, it is critical that one ideally also attempts to join a cam 4a as an anti-twist protection to the material of the connecting piece 1a, in order to thus obtain a highly stressable anti-twist protection.

It is obvious that this entails high production expenditures.

If the entire connecting piece 1a with the pipe detent ring 3a had been produced by reshaping with a flanging tool, it would not be possible to connect the cam 4a integrally in terms of material to this material. It would then have to be connected in some fashion to the material as a separate part, which is associated with strength problems.

This is where the invention sets in, which provides in accordance with FIG. 1 that, on a connecting piece 1 consisting either of metal or plastic, which is implemented in the form of a pipe, a separate pipe detent ring 3 is placed onto the outer periphery of the pipe 2 of the connecting piece 1.

The invention provides for this purpose that the inner periphery of the pipe 2 is provided with a circumferential press groove 5, which forms a radially outwardly widening bead that engages into the inner periphery of the pipe detent ring 3, thereby connecting the same firmly and so as to be protected against sliding and twisting to the outer periphery of the pipe 2.

The advantage of this measure is that one can now carry out all machining processes on the separate pipe detent ring 3 prior to installing it. For example, provision is made that the cam 4 is formed directly onto the material of the pipe detent ring 3, since the entire pipe detent ring 3 consists of a bent sheet metal material. The cam 4 is then directly bent out of and shaped from the sheet metal material.

In other respects, it is important in this illustration that the detent means (consisting of the pipe detent ring 3) is entirely separate from the sealing surface 6 of the pipe 2, so that the pipe detent ring 3 no longer assumes any sealing tasks. This enables it to be produced particularly cost effectively, but also highly stressable.

Additional details of the invention will become apparent from FIG. 2.

In accordance with the invention, it is provided that the pipe detent ring 3 is implemented in two parts, namely consisting of an anterior detent ring 13 and a posterior lock ring 12.

The terms “anterior” and “posterior” always refer to the plug-in direction (direction of the arrow 28) of a plug 20 (see FIG. 3) that can be plugged onto and detented on the connecting piece 1.

The invention is not limited to the two-part design of a pipe detent ring 3. Provision may also be made in a different embodiment that only the detent ring 13 is present and the posterior lock ring 12 is absent.

It is important that the anterior detent ring 13 forms a detent groove 7, which may be implemented very acute-angled (small radius 11), since the pipe detent ring 3 can be drawn from a highly stressable sheet metal.

The detent groove 7a according to the prior art, on the other hand, was afflicted with large radii, which entailed low pull-out forces.

It is additionally important that a relatively flat detent ramp 9 can now be created, which makes it possible to attain a particularly small plug-in force, wherein this detent ramp rests with its radially inward part only on a contact surface 10 on the outer periphery of the pipe 2.

The detent ramp 9 now transitions into the above-mentioned, relatively acute-angled radius 11, which passes over into the detent groove 7.

Into the bottom of the detent groove 7 there now engages a detent spring 24 of the plug 20, which will be explained in more detail with the aid of the figures below.

Downstream of the detent groove 7, the lock ring 12 is formed integral therewith in terms of material, and forms an axial ring surface 14 with a perpendicularly, i.e., radially adjoining end-stop flange 15.

The ring surface 14 provides for the centering of the entire plug-in connection, and the end-stop flange 15 serves to protect against foreign bodies entering into the detent region, particularly into the region of the detent groove 7.

In other respects, the front end of the connecting piece 1 has disposed on it in a known manner an inlet slope 8 to facilitate the insertion into the plug 20 according to FIG. 3.

The plug 20 substantially consists of an inner part 21 and an outer part 22, which is connected integral therewith in terms of material, with the two materials consisting of a cost-effective sheet metal, which is highly stressable.

In the region of the inner part 21, slots 25 are evenly distributed about the periphery, through which the bent ends of a detent spring 24 engage, with the detent spring 24 engaging into the corresponding detent groove 7 on the connecting piece 1, for example, at three locations that are distributed over the periphery.

In the region of the inner part 21, a widened groove is provided, which has a lip seal 23 inserted into it.

This lip seal 23 cooperates with the above-described sealing surface 6 on the connecting piece 1.

Disposed on the outer part 22 is a half-round, wing-like plastic cover 26, to cover the detent spring 24 toward the outside.

Formed between the inner part 21 and outer part 22 is a hose receiving space 27 into which a hose (not depicted) will be placed.

The invention is not limited, however, to the formation of a hose receiving space 27 for receiving a hose. Provision may also be made that a hose is directly injection-molded onto the entire plug 20.

Provision may also be made that the entire plug 20 is formed onto a pipe.

In the region of the outer part 22, an anti-twist protection recess 29 is additionally worked in, which cooperates with a corresponding cam 4 on the connecting piece 1 to provide an anti-twist protection for the plug-in connection.

In FIG. 4, the two parts 1, 20 of FIGS. 2 and 3 are depicted shortly prior to creating the plug-in connection. It is visible that the detent spring 24 engages with bent ends through the corresponding slots 25 of the plug 20 and engages altogether at different locations in a detenting manner into the detent groove 7 of the connecting piece 1.

To release the detent connection, it suffices to grasp the detent spring at one end that projects beyond the outer part 22 and raise it, in order to thus move the spring ends of the detent spring 24 out of engagement with the detent groove 7 of the connecting piece 1.

The same conditions are depicted in FIG. 5, where the plugged-in detent connection is depicted partially cut open.

It is clearly visible that the lip seal 23 makes contact in the region of the sealing surface 6 of the pipe 2 of the connecting piece 1, and that the two-part pipe detent ring 3 consisting of the detent ring 13 and lock ring 12 assumes only the detent function.

The same characteristics can also be gathered from FIG. 6, which depicts the sectional view through FIG. 5.

One can clearly see the separation of the sealing function from the detent function and the fact that the pipe detent ring 3 is secured on the outer periphery of the pipe 2 of the connecting piece 1 by means of a radially outwardly directed press groove 5.

The press groove 5 engages in front of the detent groove 7 into the material of the pipe detent ring 3, namely in the region of the detent ramp 9.

### DRAWING LEGEND

1 Connecting piece 1a
2 Pipe 2a
3 Pipe detent ring 3a
4 Cam 4a
5 Press groove
6 Sealing surface
7 Detent groove 7a
8 Inlet slope
9 Detent ramp
10 Contact surface
11 Radius
12 Lock ring
13 Detent ring
14 Ring surface
15 End-stop flange
16 -
17 -
18 -
19 -
20 Plug
21 Inner part
22 Outer part
23 Lip seal
24 Detent spring
25 Slot
26 Plastic cover
27 Hose receiving space
28 Direction of arrow
29 Anti-twist protection recess

What is claimed is:

1. A plug-in connection on pipes and hoses, said connection comprising a tubular connecting piece (1) and a tubular plug (20), which can be connected with one front end in each case to a pipe and/or hose, and which can be plugged into one another with their other front ends in a sealing manner and locked together in an axially form-fitting securing manner, said connecting piece (1) having on its pipe (2) a pipe detent ring (3) that forms a detent groove (7), into which a detent spring (24) of the plug (20) engages in a detenting manner at least partly, characterized in that the pipe detent ring (3) is implemented as a part that is separate from the connecting piece (1) and secured to the same form-fittingly with little play, or fixed to it in a form-fitting and frictionally engaging manner without play.

2. A plug-in connection according to claim 1, characterized in that the pipe detent ring (3) is situated on the outer periphery of the pipe (2) of the connecting piece (1).

3. A plug-in connection according to claim 1 or 2, characterized in that the sealing surface (6) of the connecting piece (1) is situated closer to its front end on the plug side than its detent groove (7) of the detent ring (3) and that the detent spring (24) of the plug (20) is situated closer to its front end on the connecting piece side than its gasket (23).

4. A plug-in connection according to any of claims 1 through 3, characterized in that the seal between the connecting piece (1) and plug (20) occurs by means of an annular gasket (23) of the plug (20), which contacts a sealing surface (6) of the connecting piece (I) in a sealing manner, and the sealing surface (6) of the connecting piece (1) has a purely cylindrical form and no radial indentations or convexities.

5. A plug-in connection according to any of claims 1 through 4, characterized in that the detent connection between the detent spring (24) of the plug (20) and the detent groove (7) of the pipe detent ring (3) of the connecting piece (1) is implemented either so as to not be sealing or so as to be sealing for the entire plug-in connection.

6. A plug-in connection according to any of claims 1 through 5, characterized in that the pipe detent ring (3) is secured or fixed on the connecting piece (1) by means of at least one radially outwardly and/or radially inwardly extending projection/recess of the connecting piece (1).

7. A plug-in connection according to claim 6, characterized in that the at least one radial projection/recess is implemented in the form of at least one circumferential uninterrupted or interrupted press groove (5) in the connecting piece (1).

8. A plug-in connection according to any of claims 1 through 5, characterized in that the pipe detent ring (3) is bonded to the connecting piece (1) by means of a glued connection and/or welded/soldered connection.

9. A plug-in connection according to any of claims 1 through 8, characterized in that the connecting piece (1), the pipe detent ring (3) and the plug (20) are formed of metal and/or plastic.

10. A plug-in connection according to claim 9, characterized in that the connecting piece (1) is formed of plastic and that the pipe detent ring (3) is produced of metal and/or plastic as a separate part and injection-molded onto or into the connecting piece (1).

11. A plug-in connection according to any of claims 1 through 10, characterized in that for plugging the connecting piece (1) and the plug (20) into one another, the detent ring (3) of the connecting piece (1) has a relatively flat detent ramp (9), to which a relatively small radius (11) adjoins, which passes over into the detent groove (7) via an approximately radially extending wall section.

12. A plug-in connection according to any of claims 7 through 11, characterized in that the at least one radial projection/recess, especially the press groove (7), engages into the radially inward side of the detent ramp (9) in a form-fitting and frictionally engaging manner.

13. A plug-in connection according to any of claims 1 through 12, characterized in that the pipe detent ring (3) is designed as two parts and consists of a detent ring (13) that is proximal to the plug and an adjoining lock ring (12), which in particular is integral in terms of material, that is situated away from the plug, wherein the detent ring (13) serves for the detent connection to the plug (20), whereas the lock ring (12) serves for centering the detent connection and as an axial end-stop limit.

14. A plug-in connection according to any of claims 1 through 13, characterized in that an anti-twist protection in the form of a cam (4) is provided on the pipe detent ring (3), to prevent the relative twisting movement between the connecting piece (1) and plug (20).

15. A plug-in connection according to claim 14, characterized in that the cam (4) is produced from the material of the pipe detent ring (3) by cold forming, e.g., by means of flanging or by pushing out lobes.
